(19) United States
(12) Patent Application Publication
(10) Pub. No.: US 2013/0060685 A1
(43) Pub. Date: Mar. 7, 2013

(54) SYSTEM AND METHOD FOR RECRUITING BRAINS USING SOCIAL NETWORK SERVICE

(71) Applicant: Sang Bin Om, Paju-si (KR)

(72) Inventor: Sang Bin Om, Paju-si (KR)

(21) Appl. No.: 13/541,215

(22) Filed: Jul. 3, 2012

(30) Foreign Application Priority Data
Sep. 6, 2011 (KR) 10-2011-0090049

(51) Int. Cl. G06Q 10/06; G06Q 40/00; G06F 15/16

(52) U.S. Cl. 705/40; 709/204; 705/321

(57) ABSTRACT

A brain recruiting method using a social network service according to the present invention comprises the steps of: registering a job announcement while a hiring manager logs in a social network through a user interface, the social network being connected and interacting with an application server through an Internet; transmitting the registered job announcement to at least one or more acquaintances on the social network of the hiring manager; and transmitting, by any one user or two or more users among the acquaintances receiving the job announcement, the job announcement to at least one or more acquaintances among acquaintances of the users through their user interfaces.

### BACKGROUND OF THE INVENTION

1. Field of the Invention

The present invention relates to a brain recruiting system, and more specifically, to a brain recruiting system, in which appropriate brains are recommended and hired by a company of a hiring manager through a social network service.

2. Background of the Related Art

A conventional method of recruiting brains by a company is an open recruitment, in which a job announcement is posted on the home page of the company, newspapers and the like, and applications are reviewed and interviews are conducted for a plurality of applicants applying for the job seeing the job announcement.

The open recruitment like this has some difficulties when a department in need of experienced or professional human resources in a specific field employs brains suitable for a corresponding field. On this reason, a company employs a search consultant such as a headhunter possessing an abundant human resource pool containing professional human resources of a specific field and employs appropriate brains recommended by the search consultant.

However, commissions paid to the search consultant for recommending the brains are very high, and if the amount of information on the human resources grows to be large, reliability of the search consultant managing the information can be lowered.

Meanwhile, social network services such as Facebook or Twitter are widely used recently, and if a hiring manager sends a job announcement for employing required brains to some relevant acquaintances, who make a relation with the hiring manager through a social network service that the hiring manager uses, and to acquaintances of the acquaintances and if relevant persons among the persons receiving the job announcement apply for the corresponding job, the hiring manager himself or herself, acquaintances of the manager and acquaintances of the acquaintances may play a role of a search consultant. Particularly, if the job announcement is transferred to acquaintances of the acquaintances and an acquaintance receiving the job announcement continues to transfer the job announcement to other acquaintances, the number of persons receiving the job announcement will abruptly increase, and thus possibility of finding relevant brains is increased.

Accordingly, the inventor proposes a brain recruiting system using a social network service and a method thereof.

### SUMMARY OF THE INVENTION

Therefore, the present invention has been made in view of the above problems, and it is an object of the present invention to provide a brain recruiting system using a social network service and a method thereof, in which a plurality of social network users playing a role of a search consultant may receive commissions from a company hiring recommended brains, and thus the system and method is advantageous to the company hiring the brains, the users recommending the brains, and job seekers, i.e., the recommended brains.

Another object of the present invention is to provide a brain recruiting system using a social network service and a method thereof, in which a company hiring brains can be recommended with reliable brains while paying only a small amount of commissions, obtains an effect of advertising the company using the social network service, and pays a certain amount of money to users participating in recruitment, and thus a good relation can be established between the company and the users.

Still another object of the present invention is to provide a brain recruiting system using a social network service and a method thereof, in which a user recommending a brain may have a financial benefit as a reward for recommending the brain, feel satisfaction by recommending appropriate brains, and help people around the user in developing their careers, and furthermore, the user may obtain hiring information of a company as a potential job seeker.

Still another object of the present invention is to provide a brain recruiting system using a social network service and a method thereof, in which a recommended user may move to a job field desired by the user, obtain highly reliable hiring information through an acquainted recommender, and obtain appropriate hiring information through the people around the user although the user does not looking for a job by himself or herself.

The objects described above and other inherent objects of the present invention can be achieved by the present invention described below.

To accomplish the above objects, according to one aspect of the present invention, there is provided a brain recruiting system using a social network service, in which an application server, a social network interacting with the application server through an application programming interface, and a plurality of user interfaces are connected to one another through an Internet. The user interface includes: a first user interface of a hiring manager; and a second user interface used by acquaintances having a relationship with the hiring manager on the social network, and the application server includes: an application module executed on a processor to control an interaction between the application server and the social network and to perform a function of registering a job announcement through the first user interface and transferring the job announcement to the acquaintances by the hiring manager, and applying for a job according to the job announcement received through the second user interface or re-transmitting the job announcement to acquaintances selected among acquaintances of at least one or more users, by the one or more users; and a storage for storing information on the users and information on a company of the hiring manager.

In the present invention, the application module may further perform a function of checking whether or not a member is permitted to use an application program to fetch information on the member of the social network.

In the present invention, the application module may further perform a function of issuing and sending a bill to the company if a user who has submitted the resume is finally determined to be hired.

In the present invention, the application module may further perform a function of paying a portion of a commission to a user who has re-transmitted the job announcement to the hired user among the acquaintances if the company pays the commission according to the bill.

In the present invention, the application module may further perform a function of requesting a reference check from the user who has submitted the resume and allowing the user who has registered the job announcement to select an acquaintance on the social network having a relationship with the user who has submitted the resume if the user accepts the request for reference check.

In the present invention, information received from the users may include the resume submitted according to the job announcement.

In the present invention, the storage may include a database which stores a list of questions for the reference check.

A brain recruiting method using a social network service according to the present invention includes the steps of: registering a job announcement while a hiring manager logs in a social network through a user interface, the social network being connected and interacting with an application server through an Internet; transmitting the registered job announcement to at least one or more acquaintances on the social network of the hiring manager; and transmitting, by any one user or two or more users among the acquaintances receiving the job announcement, the job announcement to at least one or more acquaintances among acquaintances of the users through their user interfaces.

In the method described above, the brain recruiting method may further include the step of applying for a company of the hiring manager who has registered the job announcement, by at least one or more users receiving the job announcement through their user interfaces.

In the present invention, the at least one or more users receiving the job announcement apply for the company of the hiring manager who has registered the job announcement by registering a resume through their user interfaces.

In the present invention, the brain recruiting method may further include the step of, if the resume is registered, requesting a reference check from the user who has registered the resume by the hiring manager.

In the present invention, the brain recruiting method may further include the steps of: permitting the request for reference check, by the user who has received the request for reference check; selecting at least two or more users among acquaintances of the user who has received the request for reference check, by the hiring manager; and transmitting a reference check questionnaire to the selected users.

In the present invention, the brain recruiting method may further include the steps of, if the resume is registered, viewing the resume by the hiring manager; and transmitting the resume to a person-in-charge in a working department.

In the present invention, the brain recruiting method may further include the steps of, when transmitting the resume to a person-in-charge in the working department, locking the resume with a one time password; and transmitting the one time password to the person-in-charge in the working department, together with the resume.

In the present invention, the brain recruiting method may further include the step of inputting information on a company of the hiring manager when the hiring manager registers the job announcement.

### BRIEF DESCRIPTION OF THE DRAWINGS

FIG. 1 is a block diagram showing a brain recruiting system using a social network service according to the present invention.

FIG. 2 is a block diagram showing the module structure of the application server of a brain recruiting system using a social network service according to the present invention.

FIG. 3 is a block diagram showing the structure of the user information database of a brain recruiting system using a social network service according to the present invention.

FIG. 4 is a block diagram showing the structure of the company information database of a brain recruiting system using a social network service according to the present invention.

FIG. 5 is a block diagram showing the structure of the management information database of a brain recruiting system using a social network service according to the present invention.

FIG. 6 is a block diagram showing the structure of the reference check information database of a brain recruiting system using a social network service according to the present invention.

FIG. 7 is a flowchart illustrating a process of a hiring manager in a brain recruiting system using a social network service according to the present invention.

FIG. 8 is a flowchart illustrating a process of transferring a job announcement to another recommender by a user receiving the job announcement in a brain recruiting system using a social network service according to the present invention.

FIG. 9 is a flowchart illustrating a process of applying for a company by a user receiving a job announcement in a brain recruiting system using a social network service according to the present invention.

FIG. 10 is a flowchart illustrating a process of sharing information on an applicant between a hiring manager and a working department in a brain recruiting system using a social network service according to the present invention.

FIG. 11 is a flowchart illustrating a process related to reference check in a brain recruiting system using a social network service according to the present invention.

FIG. 12 is a flowchart illustrating a process performed after hiring an applicant by a company in a brain recruiting system using a social network service according to the present invention.

| | |
|---|---|
| 100: Application server | |
| 110: Application module | |
| 111: Social network controller | |
| 112: In-out box controller | |
| 113: Recruit controller | 114: User controller |
| 115: Resume controller | 120: Storage |
| 121: User information database | |
| 122: Company information database | |
| 123: Management information database | |
| 124: Reference check database | |
| 200: Social network | |
| 250: Application programming | |
| interface (API) | |
| 300: Internet | 400: User interface |
| 401: First user interface | 402: Second user interface |
| 403: Third user interface | |

### DETAILED DESCRIPTION OF THE PREFERRED EMBODIMENT

The preferred embodiments of the invention will be hereafter described in detail, with reference to the accompanying drawings.

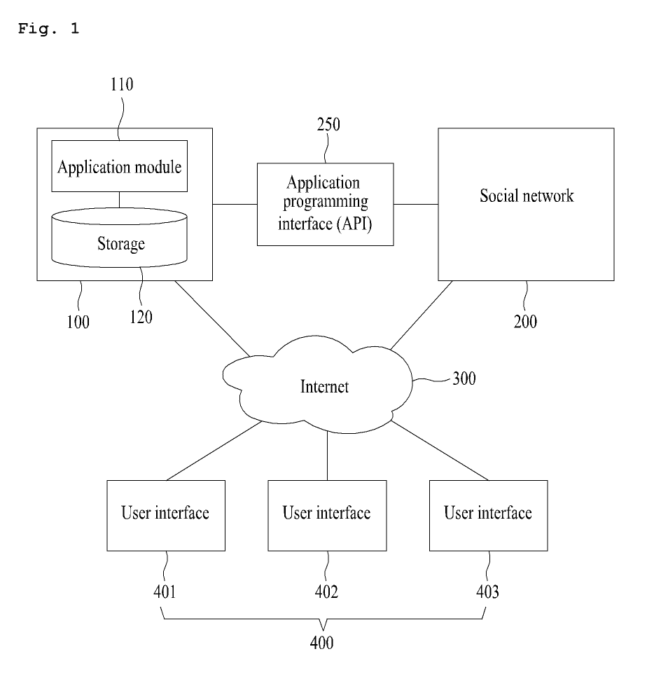

FIG. 1 is a block diagram showing a brain recruiting system using a social network service according to the present invention.

As shown in FIG. 1, a brain recruiting system using a social network service according to the present invention includes an application server 100, a social network 200, an Internet 300, and a user interface 400.

The application server 100 includes an application module 110 for executing the brain recruiting system according to the present invention and a storage 120 for storing a variety of data. The application server 100 of the present invention may be configured with a server or two or more servers optionally. If the application server 100 is configured with two or more servers, the servers can be connected to one another through an appropriate network such as the Internet. The server may be a computer such as equipment mounted on a desk top or a rack, or the server may be configured with a plurality of computers. The plurality of computers may be installed in a room together or may be separately positioned in a plurality of places, as long as they are connected to one another through an internal or external network.

The application server 100 of the present invention includes at least one or more processors in order to execute the application module 110 and store a variety of data in the storage 120. In addition, the storage 120 is a storage medium well known to those skilled in the art. For example, the storage 120 may be a hard disk drive, a compact disk (CD), a digital video disk (DVD), a nonvolatile flash memory, or the like.

The social network 200 of the present invention provides an open application programming interface like Facebook. Accordingly, functions provided by the application server 100 of the present invention can be used in the services provided by the social network 200. For example, if a user having a membership of the Facebook is permitted to use an application program of the present invention, an interface is provided to allow the user to register a job announcement, transfer the job announcement and register a resume through the user interface. The application module 110 of the present invention includes a module for performing such a function. The application programming interface (API) 250 enables the social network 200 to interact with the application server 100.

The user interface 400 includes devices capable of using the Internet, such as a desktop computer, a laptop computer, a cellular phone, a PDA and the like. The user interface 400 includes first to third user interfaces 401 to 403, and a user may connect to the social network 200 on the Internet 300 and use social network services through each of the user interfaces. For example, in the case of the Facebook, a user joins as a member and uses corresponding social network services. Although FIG. 1 shows three user interfaces as an example, it is apparent that the number of user interfaces can be increased to be more than three.

In the present specification, a ‘user’ is a member of the social network 200 and can be a hiring manager belonging to a company that needs to hire brains, an acquaintance of the hiring manager who receives a job announcement sent by the hiring manager, or an acquaintance of the acquaintance, and this can be continuously expanded to acquaintances of the acquaintance and so on. An ‘applicant’ is a person applying for the company according to the job announcement. Naturally, the hiring manager himself or herself can be an applicant according to a job announcement of another company. A ‘conveyor’ is a person receiving the job announcement and transferring the job announcement to his or her acquaintances. The ‘acquaintance’ is a person having a relationship with the user who has joined the social network. In the case of the Facebook, the ‘acquaintance’ may be a person registered as a ‘friend’ or a ‘family member’.

For the convenience of explanation in the present specification, it is described such that the first user interface 401 is a user interface of the hiring manager, the second user interface 402 is a user interface of the conveyor, who is one of the acquaintances of the hiring manager receiving a job announcement from the hiring manager and transferring the job announcement to his or her acquaintance, and the third user interface 403 is a user interface of an applicant, who is one of the acquaintances of the conveyor receiving the job announcement from the conveyor and applying for the company. It is apparent in reality that the conveyor may be some of the acquaintances of the hiring manager, and the applicant may be one or some of the acquaintances of the hiring manager or the conveyor. An acquaintance of the conveyor can be another conveyor, and one or some of the acquaintances can be an applicant.

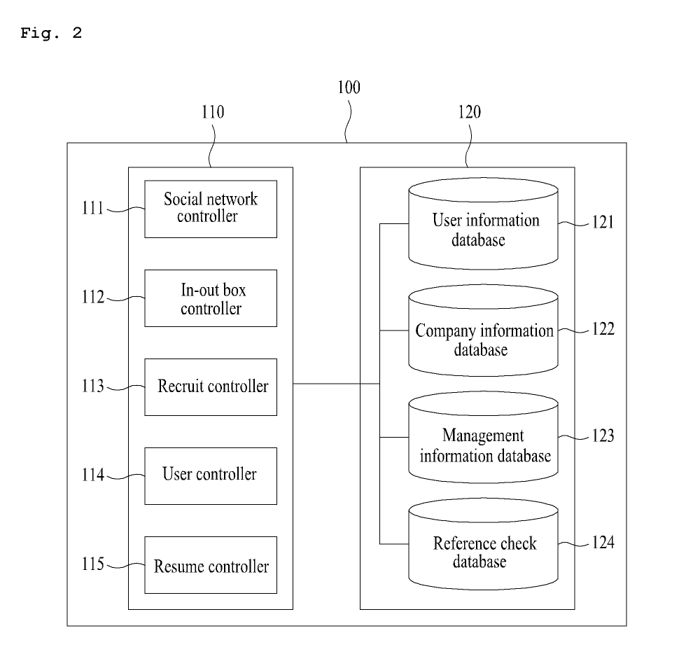

FIG. 2 is a block diagram showing the structure of the application server 100 of a brain recruiting system using a social network service according to the present invention.

As shown in FIG. 2, the application server 100 of the present invention largely includes an application module 110 and a storage 120. The application module 110 includes a social network controller 111, an in-out box controller 112, a recruit controller 113, a user controller 114 and a resume controller 115.

The social network controller 111 is a module for controlling something which interacts with the social network 200 such as the Facebook. In order to allow the application server 100 to use and store information on user authentication and information on the user, possessed by the social network, such as a name, an email address, a list of acquaintances or friends and the like, through the social network controller, an interface for confirming whether or not to permit the user can be provided. The in-out box controller 112 enables transmission and storage of information, notification or a message to be delivered, such as transmission of a job announcement to a user, notification of hiring or rejection to an applicant or request for reference check from an applicant. The recruit controller 113 allows the hiring manager to register a job announcement and input information on the company of the hiring manager, such as a name, an address, contact information, department in charge, responsibility of the department and the like of the company, and stores the inputted information. The user controller 114 allows to process information on a user, i.e., information related to the user such as information on a bank account of the conveyor who has recommended a brain, information on a job group of the applicant and the like, as needed and store the processed information in the storage 120. The resume controller 115 allows the applicant to register and update a resume and apply for a job in the long run. The applicant may be provided with a function of viewing details of application such as his or her resume or the like in advance in a form such as PDF, before finally applying for the job.

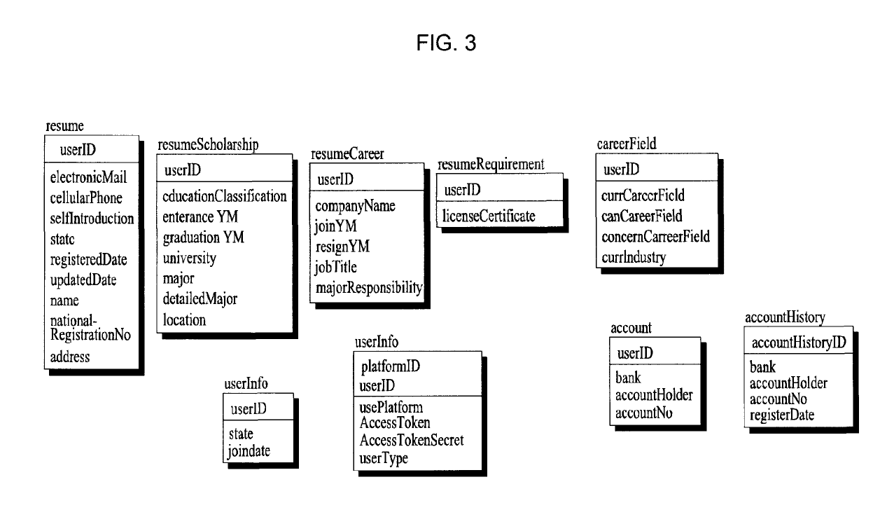

The storage 120 is a medium for storing a variety of information and includes a user information database 121, a company information database 122, a management information database 123, and a reference check information database 124. Each of the databases stores information needed as the application module 110 is performed. The structures of the databases are shown in FIGS. 3 to 6.

FIG. 3 is a block diagram showing the structure of the user information database 121 of a brain recruiting system using a social network service according to the present invention. As shown in FIG. 3, the user information database 121 stores information that is extracted from a resume registered by an applicant and information on a bank account and details of money transfer of the conveyor who has recommended the applicant.

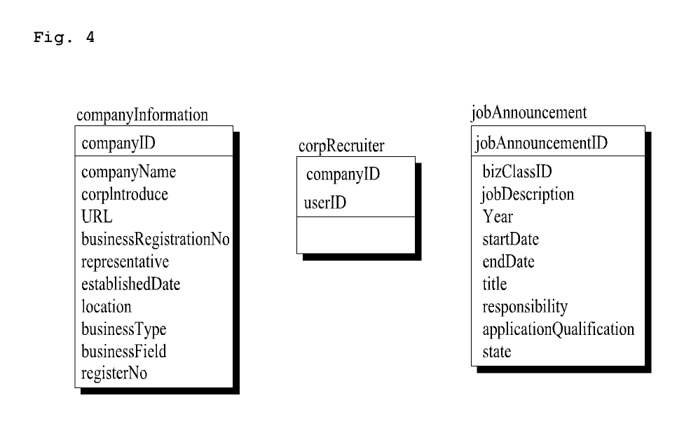

FIG. 4 is a block diagram showing the structure of the company information database 122 of a brain recruiting system using a social network service according to the present invention. Referring to FIG. 4, the company information database 122 stores information related to a company such as the name and introduction of the company and information such as a hiring manager of the company, job announcement and the like.

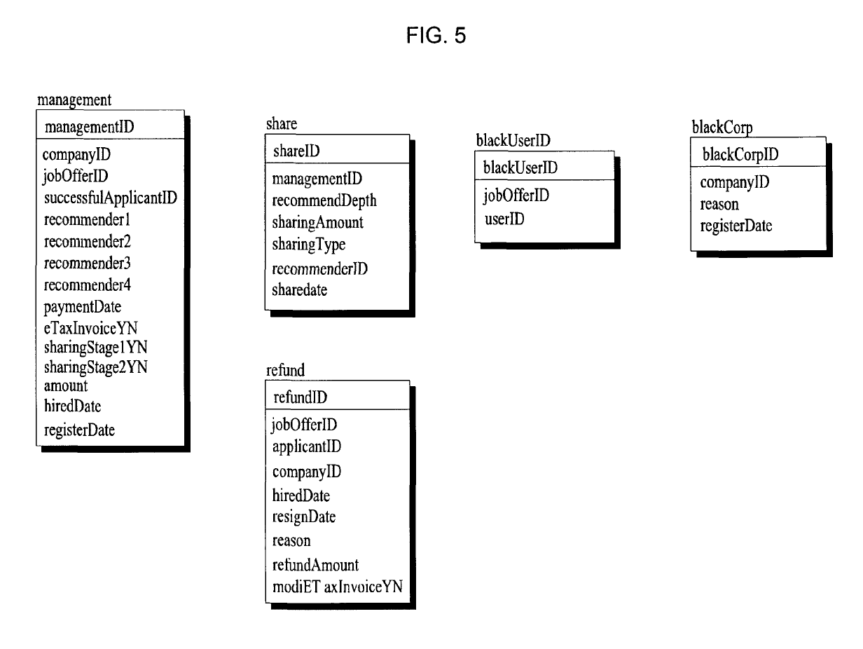

FIG. 5 is a block diagram showing the structure of the management information database 123 of a brain recruiting system using a social network service according to the present invention. As shown in FIG. 5, the management information database 123 stores information such as a company that has hired a brain in the application server 100 which provides the brain recruiting system of the present invention, a user who has recommended the brain, a commission paid to the operator of the brain recruiting system by the company, information on the bank account needed to refund a portion of the paid commission if the hired brain resigns within a certain period of time.

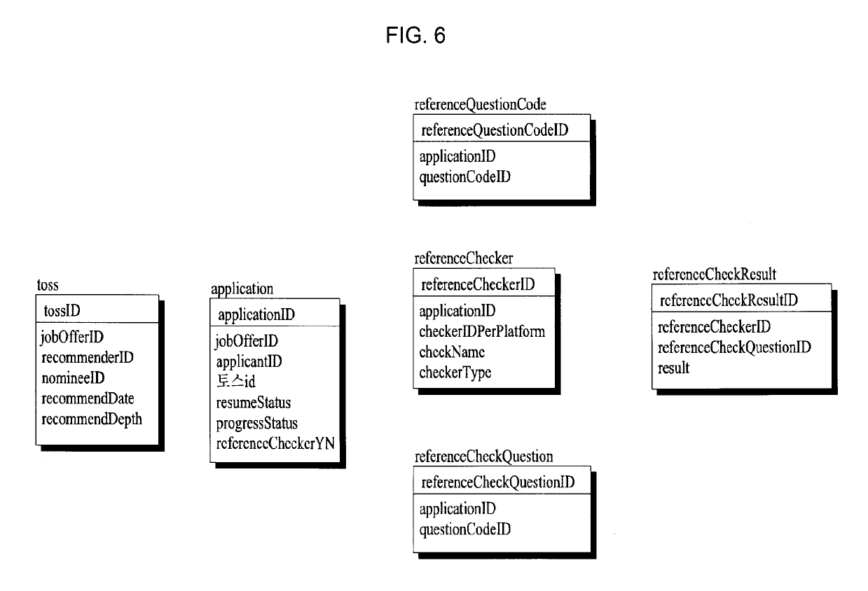

FIG. 6 is a block diagram showing the structure of the reference check information database 124 of a brain recruiting system using a social network service according to the present invention. The reference check is a process in which a company inquires reputation of an applicant from a plurality of acquaintances among acquaintances of the applicant applied for the company. To this end, the reference check information database 124 stores and manages information such as questions of reference check, information on the applicant, information on acquaintances of the applicant, acquaintances of the applicant who respond to the reference check, a result of the reference check, and the like.

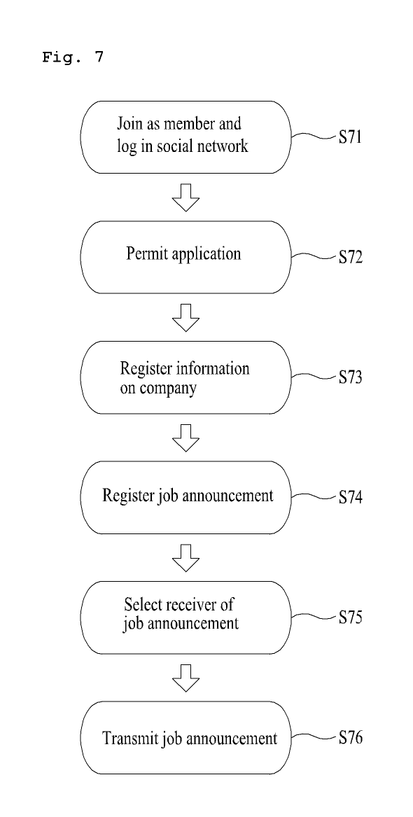

FIG. 7 is a flowchart illustrating a process of a hiring manager in a brain recruiting system using a social network service according to the present invention.

Referring to FIG. 7, first, in step S71, the hiring manager connects to the social network 200 through the first user interface 401. If the hiring manager is not a member of the corresponding social network 200, the hiring manager joins as a member and then logs into the social network 200. Next, in step S72, the hiring manager is permitted to use an application program provided by the brain recruiting system 100 of the present invention depending on a message provided by the social network 200.

In step S73, the hiring manager registers information related to the company of the hiring manager. The application module 110 of the application server 100 provides items to be registered and the like, and the recruit controller 113 provides the hiring manager with an interface for inputting information on the company. The information on the company inputted by the hiring manager is stored in the company information database 122.

In step S74, the hiring manager registers a job announcement. The recruit controller 113 of the application module 110 registers the job announcement according to an input screen provided through the first user interface 401 of the hiring manager.

Next, in step S75, the hiring manager is allowed to select those who will receive the job announcement from a list of his or her acquaintances (friends) registered in the social network 200. The social network controller 111 fetches the list of acquaintances of the hiring manager from the social network 200 and provides the first user interface 401 with a screen for easily selecting receivers of the job announcement so that the hiring manager may select appropriate person(s) from the list.

In step S76, the hiring manager sends the job announcement to the persons selected among his or her acquaintances. The in-out box controller 112 transfers the job announcement in the form of an email, and a user receiving the job announcement may re-send the job announcement to appropriate persons among his or her acquaintances, or the user himself or herself can be an applicant according to the job announcement.

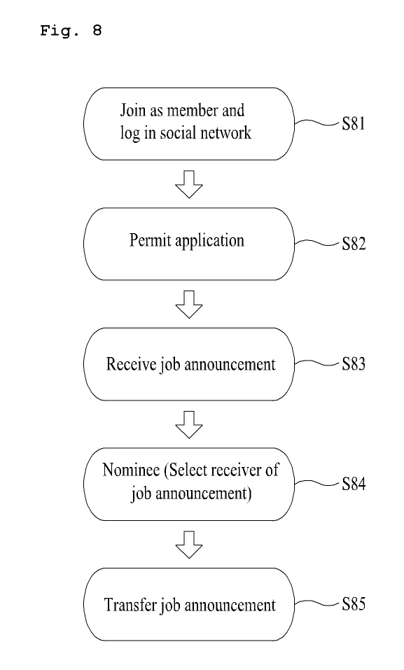

FIG. 8 is a flowchart illustrating a process of transferring a job announcement to another recommender through the second user interface 402 by a user receiving the job announcement in a brain recruiting system using a social network service according to the present invention.

As shown in FIG. 8, in step S81, a user connects to the social network 200. If the user is not a member of the corresponding social network 200, the user joins as a member and logs into the social network 200. The user using the second user interface is a member of the social network 200 and has an acquaintance relationship with the hiring manager. Next, in step S82, an application program provided by the brain recruiting system 100 of the present invention is allowed according to a message provided by the social network 200. Next, in step S83, the user receives a job announcement transmitted from the hiring manager. In the present invention, the user receiving the job announcement may receive a notification informing arrival of the job announcement through an email or an SMS, regardless of permission of the application program. Next, the user may confirm details of the job announcement after connecting to the corresponding social network and being permitted to use the application program. That is, the sequence of step S82 and step S83 may be changed.

Next, in step S84, after receiving the job announcement and confirming details thereof, the user may select ‘apply’ depending on the details of the corresponding job announcement or select ‘transfer’ to select his or her acquaintances and re-transmit the job announcement. The in-out box controller 122 provides a screen for transferring a message such as the job announcement or the like or applying for the job. If the user selects ‘transfer’, the user using the second user interface 402 in the embodiment becomes a conveyor. In step S84, the conveyor selects person(s) who will receive the job announcement among his or her acquaintances, i.e., selects at least one or more nominees.

In step S85, the conveyor transmits the job announcement to the selected nominees in the form of an email or an SMS.

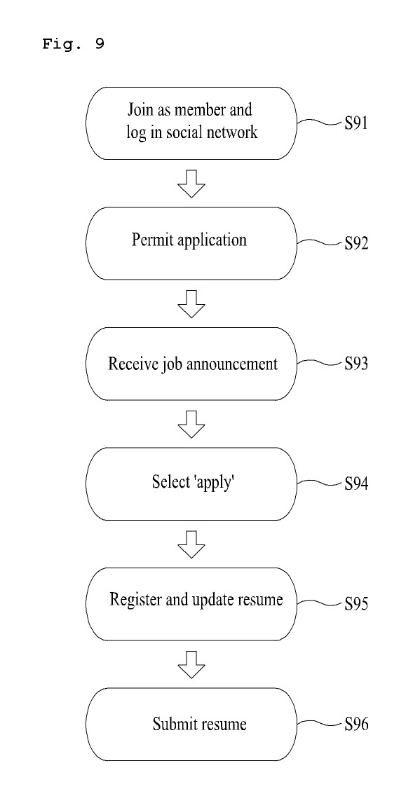

FIG. 9 is a flowchart illustrating a process of applying for a company by a user receiving a job announcement in a brain recruiting system using a social network service according to the present invention.

As shown in FIG. 9, in step S92, a user receiving the job announcement is already a member of the social network 200. In addition, the user has an acquaintance relationship with the conveyor who has received and re-transmitted the job announcement.

Next, in step S92, an application program provided by the brain recruiting system of the present invention is allowed depending on a message provided by the social network 200. Next, in step S93, the user receives the job announcement re-transmitted by the conveyor. In the present invention, the user receiving the job announcement may receive a notification informing arrival of the job announcement through an email or an SMS, regardless of permission of the application. Next, the user may confirm details of the job announcement after connecting to the corresponding social network and being permitted to use the application program. That is, the sequence of step S92 and step S93 may be changed.

Next, in step S94, the user receiving the job announcement confirms details of the received job announcement and selects ‘apply’. The in-out box controller 122 provides a screen for transferring a message such as the job announcement or the like or applying for the job. Although the user may select ‘apply’ or select ‘transfer’ ro select his or her acquaintances and re-transmit the job announcement, in this embodiment, a case in which the user receiving the job announcement from the conveyor selects ‘apply’ will be described. Therefore, the user using the third user interface 403 becomes an applicant in step S94.

Next, in step S95, the applicant registers a resume. The resume controller 115 provides an input screen needed for an applicant to input details of the resume through the third user interface 403. Information in each field of the resume inputted by the applicant can be updated at any time.

Next, in step S96, the resume completed to be inputted and updated is submitted. The resume controller 115 provides a screen needed for the applicant to submit the resume through the third user interface 403.

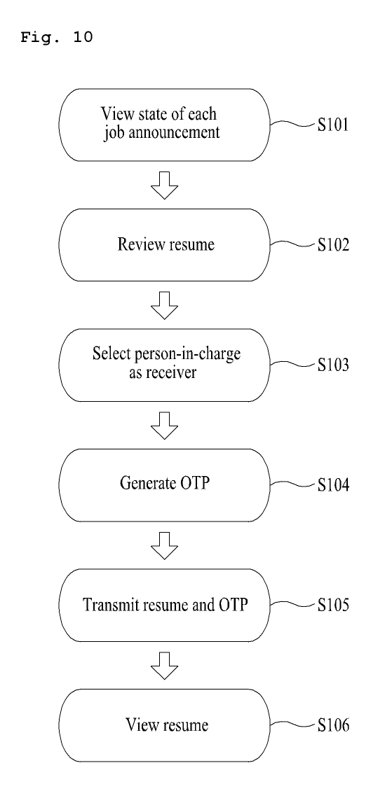

FIG. 10 is a flowchart illustrating a process of sharing information on an applicant between a hiring manager and a working department in a brain recruiting system using a social network service according to the present invention.

If the hiring manager of a company which has posted a job announcement in order to hire brains logs into the social network 200 through the first user interface 401 and accesses to the brain recruiting system of the present invention, the hiring manager may check the current state according to the job announcement in step S101. In step S102, the hiring manager may select a submitted resume and confirm details of the resume. Preferably, among the details of the resume of an applicant that the hiring manager is provided with through the first user interface 401, items related to personal information, such as a name, an email address, a cellular phone number and the like of the applicant, are blind-processed so that the hiring manager may not view the personal information. The reason is that it needs to prevent the hiring manager from searching and collecting personal details or information on the people around the applicant by searching for contents of a personal blog or the like on the social network 200 or through the Internet 300 using the personal information of the applicant obtained from the resume.

Next, in step S103, in order to transmit the submitted resume to a person-in-charge in a working department that needs to hire a person, i.e., the target of the corresponding job announcement, the hiring manager may select the person-in-charge in the corresponding working department among his or her acquaintances included in the members of the social network 200. The selected person-in-charge may be one person or two or more persons. The selected person-in-charge is a member of the social network 200 and has an acquaintance relationship with the hiring manager.

Next, in step S104, due to the reason of security, a one time password (OTP) is created to limit the persons who can view the transmitted resume or to limit the time duration of viewing the resume or the number of times for viewing the resume, and the resume is locked so as to be shown only if the OTP is inputted when the resume viewed. Then, in step S105, the resume and the password (OTP) are transmitted to the person-in-charge. At this point, a message informing that the resume has been transmitted may be notified to the person-in-charge in the form of an email, an SMS or the like. Next, in step S106, the person-in-charge receiving the resume may view the received resume using the transmitted one time password (OTP).

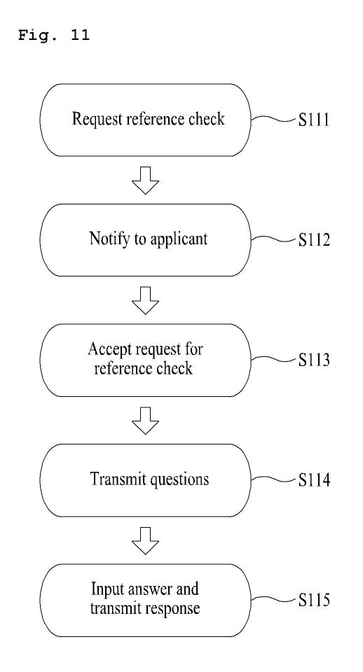

FIG. 11 is a flowchart illustrating a process related to reference check in a brain recruiting system using a social network service according to the present invention.

Referring to FIG. 11, in step S111, the hiring manager may request a reference check through the first user interface 401. If the reference check is requested by the hiring manager, in step S112, the request for reference check is transmitted to the applicant by the in-out box controller 112. The applicant who has submitted the resume through the third user interface 403 may accept or reject the request for reference check. If the applicant rejects the request, the process is terminated without performing the reference check, and if the applicant accepts the request in step S113, the hiring manager selects a plurality of persons among acquaintances of the applicant and transmits a list of questions fetched from the reference check database in step S114. The plurality of acquaintances receiving the list of questions inputs answers and responds to the questions in step S115.

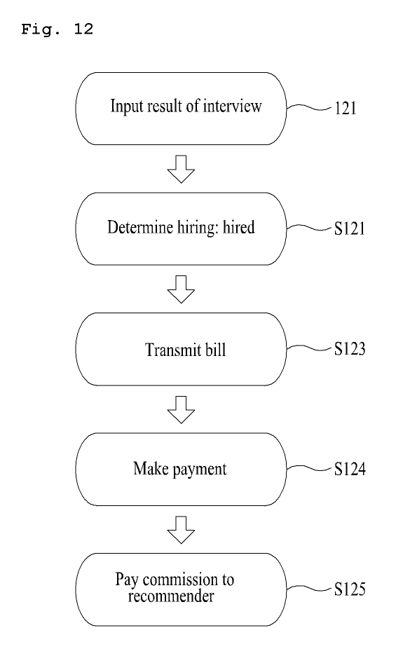

FIG. 12 is a flowchart illustrating a process performed after hiring an applicant by a company in a brain recruiting system using a social network service according to the present invention.

First, the hiring manager reviews the resume of an applicant, and if the resume is accepted, the hiring manager personally informs the applicant of the acceptance, and arranges a schedule for interview and conducts an interview. The result of the interview can be inputted through the first user interface 401, and a variety of related information is stored in each database. Then, the hiring manager registers a result of determination on whether or not to hire the applicant. If the applicant is finally determined to be hired in step S122, the company operating the application server 110 of the present invention and providing the brain recruiting system receives a certain amount of commission from the company that hires the brain using the system of the present invention after the hiring process is completed. To this end, in step S123, the in-out box controller 111 of the application module 110 issues a bill and transmits the bill to the hiring manager or an accountant of the company. Next, in step S124, the company receiving the bill pays the commission. Next, in step S125, the company operating the application server 110 and providing the brain recruiting system of the present invention pays a certain amount of commission to the conveyor who has recommended the applicant. At this point, information on the conveyor for paying the commission is processed by the user controller 114 and stored in the database.

The present invention provides a brain recruiting system using a social network service and a method thereof, in which a plurality of social network users playing a role of a search consultant may receive commissions from a company hiring recommended brains, and thus the system and method is advantageous to the company hiring the brains, the users recommending the brains, and job seekers, i.e., the recommended brains.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A brain recruiting system using a social network service, in which an application server, a social network interacting with the application server through an application programming interface, and a plurality of user interfaces are connected to one another through an Internet, wherein the user interface includes:
a first user interface of a hiring manager; and
a second user interface used by acquaintances having a relationship with the hiring manager on the social network, and the application server includes:
an application module executed on a processor to control an interaction between the application server and the social network and to perform a function of registering a job announcement through the first user interface and transferring the job announcement to the acquaintances by the hiring manager, and applying for a job according to the job announcement received through the second user interface or re-transmitting the job announcement to acquaintances selected among acquaintances of at least one or more users, by the one or more users; and
a storage for storing information on the users and information on a company of the hiring manager.

2. The system according to claim 1, wherein the application module further performs a function of checking whether or not a member is permitted to use an application program to fetch information on the member of the social network.

3. The system according to claim 1, wherein the application module further performs a function of issuing and sending a bill to the company if a user who has submitted the resume is finally determined to be hired.

4. The system according to claim 3, wherein the application module further performs a function of paying a portion of a commission to a user who has re-transmitted the job announcement to the hired user among the acquaintances if the company pays the commission according to the bill.

5. The system according to claim 1, wherein the application module further performs a function of requesting a reference check from the user who has submitted the resume and allowing the user who has registered the job announcement to select an acquaintance on the social network having a relationship with the user who has submitted the resume if the user accepts the request for reference check.

6. The system according to claim 1, wherein information received from the users includes the resume submitted according to the job announcement.

7. The system according to claim 1, wherein the storage includes a database which stores a list of questions for the reference check.

8. A brain recruiting method using a social network service, the method comprising the steps of:
registering a job announcement while a hiring manager logs in a social network through a user interface, the social network being connected and interacting with an application server through an Internet;
transmitting the registered job announcement to at least one or more acquaintances on the social network of the hiring manager; and
transmitting, by any one user or two or more users among the acquaintances receiving the job announcement, the job announcement to at least one or more acquaintances among acquaintances of the users through their user interfaces.

9. The method according to claim 8, further comprising the step of
applying for a company of the hiring manager who has registered the job announcement, by at least one or more users receiving the job announcement through their user interfaces.

10. The method according to claim 9, wherein the at least one or more users receiving the job announcement apply for the company of the hiring manager who has registered the job announcement by registering a resume through their user interfaces.

11. The method according to claim 10, further comprising the step of, if the resume is registered, requesting a reference check from the user who has registered the resume by the hiring manager.

12. The method according to claim 11, further comprising the steps of:
permitting the request for reference check, by the user who has received the request for reference check;
selecting at least two or more users among acquaintances of the user who has received the request for reference check, by the hiring manager; and
transmitting a reference check questionnaire to the selected users.

13. The method according to claim 10, further comprising the steps of, if the resume is registered,
viewing the resume by the hiring manager; and
transmitting the resume to a person-in-charge in a working department.

14. The method according to claim 8, further comprising the step of
inputting information on a company of the hiring manager when the hiring manager registers the job announcement.
